(19) United States
(12) Patent Application Publication
(10) Pub. No.: US 2014/0161061 A1
(43) Pub. Date: Jun. 12, 2014

(54) HYBRID ARQ SYSTEM USING A SLIDING PURGE WINDOW FOR WIRELESS NETWORKS

(71) Applicant: XG TECHNOLOGY, INC., SARASOTA, FL (US)

(72) Inventors: JINU KURIAN, SUNRISE, FL (US); SREEKANT NAIR, PLANTATION, FL (US); NEERAJ PODDAR, PLANTATION, FL (US)

(73) Assignee: XG TECHNOLOGY, INC., SARASOTA, FL (US)

(21) Appl. No.: 14/101,450

(22) Filed: Dec. 10, 2013

Related U.S. Application Data
(60) Provisional application No. 61/735,264, filed on Dec. 10, 2012.

(51) Int. Cl. H04L 5/00; H04L 1/08

(52) U.S. Cl. CPC H04L 5/0055; H04L 1/08
USPC 370/329

(57) ABSTRACT

An IP packet transmission system is disclosed and more specifically it is a system using a hybrid ARQ method that includes a sliding purge window to reduce packet losses and improve TCP throughput thus ensuring data integrity, improving reliability, and to some extent guaranteeing in-order delivery of packets at the receiver.

### CROSS-REFERENCE TO RELATED APPLICATION

The present application claims the benefit of previously filed co-pending Provisional Patent Application, Ser. No. 61/735,264 filed Dec. 10, 2012.

### FIELD OF THE INVENTION

This disclosure describes an IP packet transmission system, and more specifically is a system using a hybrid automatic repeat request (ARQ) method that includes a sliding purge window to reduce packet losses and improve transport control protocol (TCP) throughput thus ensuring data integrity, improving reliability, and to some extent guaranteeing in-order delivery of packets at the receiver.

### BACKGROUND OF THE INVENTION

Impairments in wireless channels can cause bit errors that result in packet losses and adversely impact TCP throughput. ARQ mechanisms are widely used in wireless communication networks as a method to alleviate these issues, ensure data integrity, improve reliability, and to some extent guarantee in-order delivery of packets at the receiver.

When implemented at the link layer, in conjunction with Fragmentation and Re-assembly techniques, along with a sliding window approach, the transmitter usually can send multiple IP packets that are fragmented into several media access control (MAC) layer fragments. These fragments can be sent out of order and are then re-assembled at the receiver. This reassembly requires a MAC layer fragment identifier and sequence number. When the wireless channel degrades, as in a deep fade, the losses can continue for extended periods of time and within a second the receiver and transmitter can get out of sync because the acknowledgment messages (ACKs) are lost. What is proposed in this disclosure is a novel scheme to alleviate this problem so that the state machines at the receiver and transmitter recover and re-sync by maintaining a “Sliding Purge Window” alongside the Sliding Transmission Window.

### BRIEF SUMMARY OF THE INVENTION

This invention describes an IP packet transmission system, and more specifically is a system using a hybrid ARQ method including a sliding purge window to reduce packet losses and improve TCP throughput thus ensuring data integrity, improving reliability, and to some extent guaranteeing in-order delivery of packets at the receiver.

### DESCRIPTION OF THE DRAWINGS

For a fuller understanding of the nature and objects of the invention, reference should be made to the accompanying drawings, in which:

FIG. 1 is a diagram showing loss of synchronization between transmitter and receiver; and,

FIG. 2 is a table showing a purge window example.

### DETAILED DESCRIPTION OF THE INVENTION

ARQ and Hybrid ARQ schemes are implemented on almost all wireless networks because they improve conventional TCP performance. However, almost all ARQ schemes assume some degree of reliability for the acknowledgement message (ACK/NACK) that is sent by the receiver so that the transmitter can re-transmit lost packets. This is usually only applicable in ideal conditions.

In wireless environments, particularly in interference prone conditions in unlicensed and ISM bands, the uplink and downlink channels are asymmetric and each suffers from varying probabilities of loss. In some systems the uplink (Mobile Station to Base Station/Access Point) has a slightly higher probability of loss because in many cases the transmitter is battery operated and the receiver is located on a building/tower with high gain antennas thereby increasing its susceptibility to interference. In such cases a loss of the uplink ACK is more detrimental because nothing can be assumed about the success of the downlink data packets. Therefore most schemes when implemented usually show a degraded performance because the assumption that the ACK/NACK is reliable is flawed.

An improved hybrid ARQ scheme is described in this disclosure that works in conjunction with Fragmentation and Re-assembly. Therefore a single IP packet from the higher layer can be fragmented into smaller chunks and is treated as individual frames. These frames are re-assembled at the receiver and forwarded to the destination as the original IP packet. Such frames are identified with a packet id and sequence number and treated as normal IP packets are at higher layers. When the wireless channel is subjected to extended periods of deep fades/losses, the transmitter and receiver can quickly get out of sync with respect to the packets being sent and what is expected. This invention disclosure proposes a novel technique that allows ARQ schemes to quickly recover from incorrect states between the transmitter and receiver. This technique is generic and can be implemented in any network. Described in this disclosure is one embodiment of this as implemented in xMax Networks. Several other embodiments can also be made using the same concept.

Normally each IP packet can be sub-divided into several MAC layer packet data units (PDUs) depending on the amount of bandwidth assigned and the transmitter may send frames belonging to different IP packets within the same super-frame. Therefore one MAC PDU may contain payload data of one IP packet while the next may contain data of another IP packet. Therefore the receiver needs to know a‘ priori’ to which IP packet the arriving data belongs. This is achieved with a MAC layer Packet ID. To minimize MAC overhead a 4 bit Packet ID is used. Therefore this can wrap around after 16 outstanding IP packets. The assumption here is that as packets are read from the queue they assigned packet IDs in a monotonically increasing order. Therefore the receiver should only expect the same packet ID if it has wrapped around and all subsequent packets have been sent. Also the sequence number denotes the relative offset of the bytes within the same IP packet (same MAC level packet ID). This allows the receiver to re-assemble the entire IP packet correctly by placing the arriving data at the right offset from the start.

When ARQ is implemented using a Sliding Window in conjunction with Fragmentation and Re-assembly, the transmitter and receiver maintain their respective windows for packets in transmission. The transmitter maintains a list of outstanding packets in the Transmission Window while the receiver maintain its own Receive Window where fragments are copied as received and finally forwarded to the next hop once all data bytes have been re-assembled. This disclosure describes a typical case where there can be a max of 4 IP packets in the Sliding Window. The method employs a selective ACK approach where received bytes/fragments are acknowledged as they are successfully received.

The access point (AP) is the master of resource allocation in both directions. In the uplink direction, mobile station (MS) to AP, a request-grant mechanism is employed to reserve bandwidth. Therefore whenever the MS has data to send it sends a request for bandwidth and also provides an indication of the Packet ID (P1) and size. The receiver side ARQ state machine now is ready to receive Packet ID P1 and allocates the necessary buffers. The receiver ARQ can hold the same number of packets in transition therefore it can accept up to a max of P1+(window size −1).

Whenever the receiver receives the last burst from a MS within a super-frame, an explicit ACK packet is formulated. This ACK contains a bitmap of all successfully received bursts and also the last successfully received in-order packet id and sequence number. When the transmitter receives this ACK, it goes back and re-transmits the lost fragments and, if assigned bandwidth remains, it sends the next set of pending data bytes.

Because this is an intelligent HARQ, which accounts for the possibility of lost ACKs, the transmitter continues to send data until the Transmission Window limit is reached. At this point the transmitter goes back to the last successfully received ACK point (in the worst case—to the start of the window) and re-transmits all the unacknowledged data. This process repeats until the retransmit limit is reached. At this point the packet has been retransmitted to the limit of the system and is dropped. The next packet is then serviced from the queue and this process repeats.

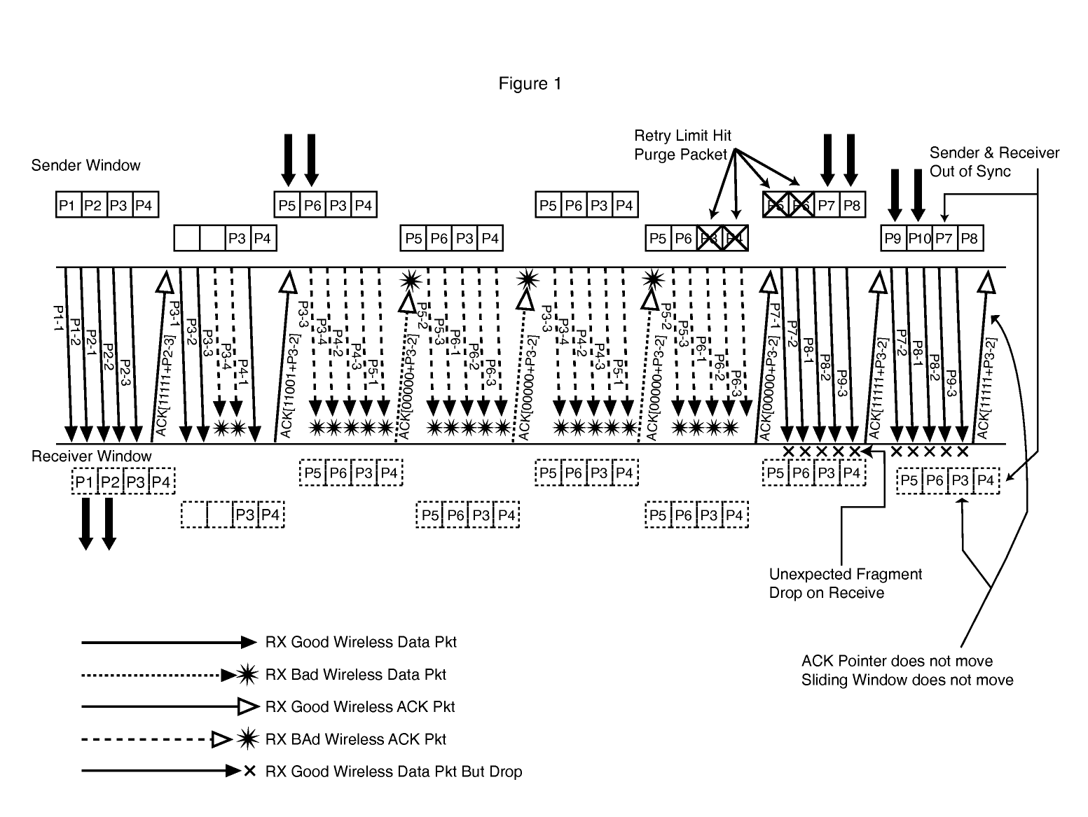

What is now described is the impact of losses or errors in the channel and how this can impact the state machine at both the transmitter and receiver. As discussed above it is clear that when there are losses and the ACK is not received, the transmitter can re-transmit a packet. On reaching the retry limit the transmitter will purge this packet from its Transmission Window and move on to the next available packet. If the losses continue it is possible that the transmitter will move ahead significantly as newer packets are constantly pulled from the arriving queue and in the end the packets in the Transmission Window and the expected packets in the Receiver's Window will be quite different. Since the transmitter continues to send fragments of packets that are not expected by the receiver, even though they are successfully received, they will be dropped as the receiver does not know how to handle these frames. This is depicted in the FIG. 1 and described in the following steps:

1. Initially the transmitter and receiver are in sync and both have packets P1, P2, P3 & P4 in their buffers.

2. Receiver successfully gets all fragments of P1 and P2. These are re-assembled and forwarded to the next hop.

3. An ACK packet that includes a bitmap of all fragments is received and the last in sequence packet & fragment is also included.

4. On receiving this ACK the transmitter purges Packets P1 and P2 from its buffer.

5. The transmitter moves the transmit pointer and continues to send the fragments of P3 and P4.

6. Two fragments are lost at the receiver. The ACK therefore has a bitmap [11001] indicating fragments P3-3 & P3-4 were lost. The sequence number shows P3-2.

7. The transmitter retransmits P3-3, P3-4 and then continues with new data of P4 onwards. Since there is free buffer available, it reads two new packets from the queue.

8. All the data fragments are lost at the receiver. The ACK bitmap indicates [00000] and in sequence packet continues as P3-2.

9. ACK is not received by the transmitter. The transmit pointer moves ahead and sends the next available packets/fragments.

10. The link continues to experience losses at both ends. After several frames, the transmitter has reached its max limit for packet P3 and P4. It purges them from its buffer. Receiver has no indication of this purge.

11. Transmitter receives ACK with in sequence of P3-2. Does not know what to do with this as it does not have P3 in its buffer. Retry limit of P5 and P6 is reached. They are purged. P7 and P8 is read from queue. Transmit pointer moves ahead and now sends new fragments belonging to P7 & P8.

12. Receiver successfully receives fragments of P7 and P8 but does not expect these packet IDs. It drops them as it cannot handle it. Continues to resend ACK with P3-2.

13. Transmitter reads two more packets from queue P9 and P10. Transmitter and receiver windows are now entirely out of sync.

Unless there is a mechanism to purge these stale packets from the Receiver Window one can clearly see that the state machines are in a state of deadlock and the data transfer effectively stops even though the link is stable again. One simple technique is to maintain a retransmit counter at the receiver and purge packets once they hit the limit. The problems with this approach are described in the next section.

The problem depicted in FIG. 1 arises because the receiver has no knowledge that the transmitter has moved on. This happens because the transmitter has hit the retry limit for a packet and picks a new one from the queue. Although it is not described explicitly in the figure, the receipt of a fragment is not the trigger for the receiver to start re-assembly. Control messages inform the receiver that it should expect a packet with Packet ID P and size n. Bandwidth is usually assigned across users on-demand and also according to a priority scheme. Therefore there may be a lag between the control message request and the actual traffic bandwidth being available. Additionally the control messages may be sent on a different channel, with a different FEC rate, or even a different modulation coding scheme (MCS) and hence have a different probability of error.

One worst case scenario that can happen is that the signaling is completed in super-frame N but right from the first data burst (in super-frame N or immediately after) the channel deteriorates. So even though the transmitter has a sense of how many times it has re-transmitted the data, the receiver does not unless it receives at least one good fragment of that packet. Thus implementing a re-transmission counter at the receiver end and purging packets when they hit the retry limit will never be accurate and can cause additional problems if the receiver incorrectly purges packets ahead of time.

Since the Packet ID field is increased monotonically, the field will wrap around to 0 or 1 at some point of time. The system should be capable of identifying it, handling the case, and moving forward. If the field is large enough then as long as the number of packet IDs is much larger than the offset, one does not have a problem. However, on low bandwidth links, it is possible that the field may only be a few bits in length. In such cases packet IDs will wrap around quicker and needs to be explicitly handled. The following use cases describe typical scenarios when the packet ID can wrap around:

a) If the first packet taken into the fragmentation buffer from the queue is a large packet followed by a bunch of smaller size packets, a wrap around can happen. If there are MAC PDUs which are lost from the first packet but the smaller packets MAC PDUs make it through, the packet IDs keep on increasing. If there are a sufficient number of small packets that have finished reassembling packet ID might wrap-around and reach the same packet ID before the old packet has either finished being reassembled or maximum retry limit has been reached for the older packet.

b) If the link between the AP and MS is deteriorating and packets are missed continuously, a wrap around can also happen. If the packets at the transmitter continuously reach their maximum retry limit and get dropped, as new packets are taken into the transmission window from the queue, packet IDs will keep on increasing. If reassembly is out of sync with fragmentation when the link recovers after some time, it might see a packet with a packet ID similar to what it already has in its buffer and reassemble the packet incorrectly.

The above discussion describes the problems encountered by ARQ schemes using a Sliding Window approach along with Fragmentation and Re-assembly. This disclosure proposes the concept of a Sliding Purge Window whereby the receiver is guaranteed to never be in a deadlock and can recover from errors resulting from a lossy channel. To ensure no deadlock in all scenarios described above this invention disclosure proposes the following measures:

The Sliding Purge Window method proposes a recovery mechanism whereby the receiver purges the oldest packet from its buffer when a fragment is received which belongs to a packet ID P(x) that is ahead by a certain offset δ. Therefore if Pᵣ is the received Packet ID, P_{c} is the current Packet ID, δ is the threshold such that we require the packet ID field itself to be able to hold sufficiently large values so that Pₘₐₓ is >δ. The following rules apply to calculate the packets that would fall in the purge window

1. If Pᵣ−P_{c}>0 AND If Pᵣ−P_{c}>δ then purge P_{c}

2. If Pᵣ−P_{c}>0 AND If Pᵣ−P_{c}<δ then retain P_{c}

3. If Pᵣ−P_{c}<0 AND If (Pₘₐₓ−P_{c}+Pᵣ)>δ then purge P_{c}

4. If Pᵣ−P_{c}<0 AND If (Pₘₐₓ−P_{c}+Pᵣ)<δ then retain P_{c}

The preferred embodiment would involve the following:

1. The Packet Identifier must be sufficiently long such that a wrap around case can be handled smoothly.

2. The retransmission logic should be such that the oldest unacknowledged packet is re-transmitted first, thus ensuring the maximum retry limit of the oldest packet will be reached first.

3. Implement a moving purge window mechanism. The purge window size (defined by δ earlier) is chosen to be large enough to ensure that by the time one sees a packet ID with purge window size ahead, the oldest packet would have been removed from the fragmentation buffer and hence can be safely removed from the reassembly buffer also.

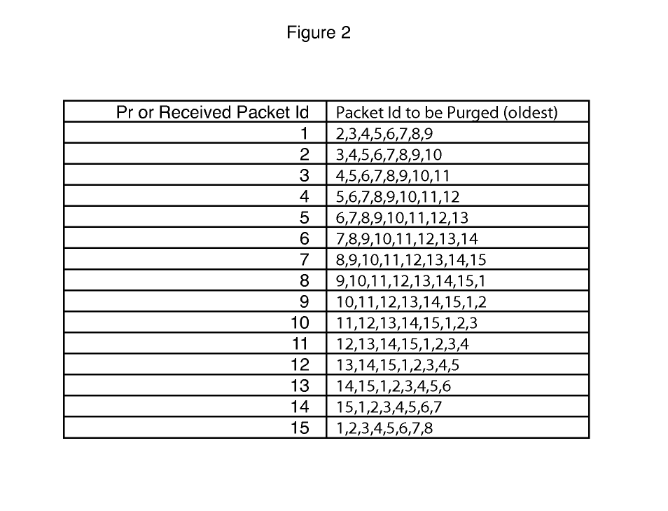

For example, in a certain embodiment where a 4 bit packet ID is used, FIG. 2 shows a solution where the purge window offset is 7.

A sliding Purge Window method that works in conjunction with a Hybrid ARQ scheme that does Fragmentation and Re-assembly at the MAC layer is described. This approach ensures that the packets in the receiver window match the ones in the transmitter window and if there is an error, it recovers and they are in sync.

Since certain changes may be made in the above described Sliding Purge Window method without departing from the scope of the invention herein involved, it is intended that all matter contained in the description thereof shall be interpreted as illustrative and not in a limiting sense.

What is claimed is:

1. A sliding purge window method to reduce packet losses and improve transport control protocol throughput in a wireless network between a receiver having a receive window, fed by a fragmentation buffer and a re-assembly buffer to re-assemble fragments of packets received, and a transmitter having a transmission window and that monotonically assigns each packet sent by the transmitter with a packet ID number up to a maximum packet ID number, said wireless network using a Hybrid Automatic Repeat Request transmission scheme having a re-transmission logic that ensures an oldest unacknowledged packet is re-transmitted first wherein the sliding purge method ensures that the packets in the receiver window match the packets in the transmission window such that if there is a transmission error the transmission scheme recovers and the receiver and transmitter remain in synchronization comprising;
said receiver having a sliding purge window;
setting a threshold packet number for said sliding purge window that is less than the maximum packet ID number; and, said receiver purging an oldest received packet from said receiver's re-assembly buffer and fragmentation buffer each time a fragment is received by said receiver that belongs to a packet having a packet ID number that is greater than the packet ID number of a packet in the fragmentation buffer and re-assembly buffer by said threshold packet number.

2. The sliding purge window method of claim 1 further comprising:
said receiver purging an oldest received packet from said receiver's re-assembly buffer and fragmentation buffer each time a new fragment is received by said receiver that belongs to a packet having a packet ID number greater than the packet ID number of a packet in the fragmentation buffer and re-assembly buffer and the difference between the packet ID number of said new fragment and the packet ID number of said packet in the fragmentation buffer and re-assembly buffer is greater than said threshold packet number; and,
said receiver purging an oldest received packet from said receiver's re-assembly buffer and fragmentation buffer each time a new fragment is received by said receiver that belongs to a packet having a packet ID number less than the packet ID number of said packet in the fragmentation buffer and re-assembly buffer and the difference between said maximum packet ID number and the packet ID number of said packet in the fragmentation buffer and re-assembly buffer then added to the packet ID number of said new fragment is less than said threshold packet number.
